(19) United States
(12) Patent Application Publication
(10) Pub. No.: US 2021/0166337 A1
(43) Pub. Date: Jun. 3, 2021

(54) INFORMATION PROCESSING APPARATUS, SYSTEM, AND NON-TRANSIENT STORAGE MEDIUM

(71) Applicant: TOYOTA JIDOSHA KABUSHIKI KAISHA, Toyota-shi (JP)

(72) Inventor: Koichi Suzuki, Miyoshi-shi (JP)

(73) Assignee: TOYOTA JIDOSHA KABUSHIKI KAISHA, Toyota-shi (JP)

(21) Appl. No.: 17/102,765

(22) Filed: Nov. 24, 2020

(30) Foreign Application Priority Data
Nov. 29, 2019 (JP) 2019-216771

(51) Int. Cl. G06Q 50/30; G06Q 50/14; G06Q 50/28; G06Q 10/06; G07C 9/00; G06Q 10/02; G01C 21/34; B60R 16/023

(52) U.S. Cl. CPC G06Q 50/30; G06Q 50/14; G06Q 50/28; G06Q 10/06312; G06Q 10/06315; G07C 2009/0092; G07C 9/00571; G07C 9/00658; G06Q 10/02; G01C 21/3484; B60R 16/0231; G07C 9/00896

(57) ABSTRACT

A technique for enabling a user who wants to be pick-up by a vehicle to collect baggage deposited elsewhere by a pick-up vehicle. An information processing apparatus obtains user information including first information indicating a desired boarding location and a desired boarding time for a user who wishes to be picked-up by a vehicle, second information indicating deposit location at which the user has deposited a user baggage, and third information indicating that a driver of a pick-up vehicle picking-up the user is permitted to receive the user baggage from the deposit location. The information processing apparatus transmits the user information to a vehicle terminal associated with the pick-up vehicle.

### CROSS REFERENCE TO THE RELATED APPLICATION

This application claims the benefit of Japanese Patent Application No. 2019-216771, filed on Nov. 29, 2019, which is hereby incorporated by reference herein in its entirety.

### BACKGROUND

### Technical Field

The present disclosure relates to a technique for allowing a user to be picked-up by a vehicle.

### Description of the Related Art

Patent Document 1 (JP-A-2019-079092) discloses a coin locker system.

In the coin locker system described in JP-A-2019-079092, the system includes a coin locker, a management server, and a user terminal are connected via networks.

In the coin locker system, settlement information for the usage fee of locker boxes in the coin locker is sent from the user terminal to the management server.

At this time, when the settlement of the usage fee of one locker box is completed, the user terminal is provided with unlock key information of one locker box whose settlement is completed.

### PRIOR ART DOCUMENT

### Patent Document

[Patent Document 1]

JP-A-2019-079092

### SUMMARY

It is an object of the present disclosure to provide a technique for enabling a user who wants to be picked-up by a vehicle to also have the pick-up vehicle collect a baggage deposited elsewhere.

An information processing apparatus according to first aspect of the present disclosure comprises a controller,
the controller configured to execute:
obtaining user information including first information indicating a desired boarding location and a desired boarding time for a user who wishes to be picked-up by a vehicle, second information indicating a deposit location at which the user has deposited a user baggage, and third information indicating that a driver of a pick-up vehicle picking up the user is permitted to receive the user baggage from the deposit location; and
transmitting the user information to a vehicle terminal associated with the pick-up vehicle.

A system according to second aspect of the present disclosure includes:
a user terminal owned by a user who wishes to be picked-up by a vehicle,
an information processing apparatus for receiving user information from the user terminal, the user information including first information indicating a desired boarding location and a desired boarding time for the user, second information indicating a deposit location at which the user deposited a user baggage, and third information indicating that a driver of a pick-up vehicle picking up the user is permitted to receive the user baggage from the deposit location, and
a vehicle terminal associated with the pick-up vehicle, wherein the vehicle terminal receives the user information from the information processing apparatus.

A non-transient storage medium according to third aspect of the present disclosure stores therein a program causing a processor to control a user terminal owned by a user who wishes to be picked up by a vehicle to execute an information processing method, wherein the information processing method comprises:
generating user information including first information indicating a desired
boarding location and a desired boarding time for the user, second information indicating a deposit location at which the user deposited a user baggage, and third information indicating that a driver of a pick-up vehicle picking up the user is permitted to receive the user baggage from the deposit location, and
transmitting the user information to an information processing apparatus operable for communicating with a vehicle terminal associated with the pick-up vehicle.

It should be noted that the present disclosure can also be regarded as a method including at least a part of the processes executed by information processing apparatus, the system, or the program stored in the non-transient storage medium, as described above.

According to this disclosure, a user who wishes to be picked-up by a vehicle can collect baggage located at another location by the pick-up vehicle.

### BRIEF DESCRIPTION OF THE DRAWINGS

FIG. 1 is a diagram showing a schematic configuration of a vehicle allocation system according to preferred embodiments.

FIG. 2 is a diagram showing an outline of a key system of a locker.

FIG. 3 is a block diagram schematically showing an exemplary functional configuration of each of a user terminal, a management server, and a driver terminal.

FIG. 4 is a diagram illustrating an exemplary operating screen displayed on the touch panel display of an input/output unit.

FIG. 5 is a diagram showing an exemplary table configuration of vehicle information database in a management server.

FIG. 6 is a flow chart showing the flow of information processing executed by a controller of user terminal.

FIG. 7 is a diagram showing an exemplary table structure of user information according to a first embodiment.

FIG. 8 is a sequence diagram showing a flow of information in the vehicle dispatching system and information processing executed in each of the management server and driver terminal.

FIG. 9 is a diagram showing an exemplary table configuration of user information according to a second embodiment.

### DESCRIPTION OF THE EMBODIMENTS

According to a first aspect of the present disclosure, in an information processing apparatus, a controller obtains user information of the user wishing to be picked-up by a vehicle.

In this example, the user has deposited his/her baggage at a location other than the pick-up location of the user, but the user also wants to collect the baggage from the other location

Here, the user information includes a first information, a second information, and a third information.

The first information is information showing a desired boarding location and a desired boarding time for the user.

Desired boarding location is a location where the user wants to be picked-up by the pick-up vehicle.

Desired boarding time is the time at which the user wants to be picked-up by the pick-up vehicle.

The second information is user baggage information that indicates a deposit location at which the user left the user's baggage.

The third information is information indicating that the driver of the pick-up vehicle picking up the user is permitted to receive the user's baggage from the deposit location.

It should be understood that the user baggage is not the pick-up vehicle driver's own baggage. Therefore, in order for the driver of the pick-up vehicle to receive the user baggage from the deposit location, the driver needs to obtain the third information, i.e., the permission information.

In the information processing apparatus according to an exemplary embodiment, a controller is operable to transmit the obtained user information to the vehicle terminal, which is the terminal associated with the pick-up vehicle.

The vehicle terminal is a terminal capable of communicating with the information processing apparatus.

In addition, the vehicle terminal is a terminal that can be operated by a pick-up vehicle driver. The vehicle terminal can obtain the first information, the second information, and the third information by receiving the user information.

The vehicle terminal is able to obtain the first information, allowing the pick-up vehicle to pick up the user at the user's desired boarding time at the user's desired boarding location. Also, the vehicle terminal can obtain the second information to allow the pick-up vehicle to go to the user baggage's deposit location on its way to the user's pick-up location.

The vehicle terminal is also able to obtain the third information, providing permission for allowing the pick-up vehicle driver to receive the user's baggage from user baggage's deposit location.

Thus, the disclosed information processing apparatus allows the pick-up vehicle to collect the user baggage that the user has deposited elsewhere, prior to the pick-up vehicle picking-up the user at the pick-up location.

Hereinafter, specific embodiments of the present disclosure will be described with reference to the drawings.

The dimensions, materials, shapes, relative arrangements, and the like of the constituent parts described in the present embodiment are not intended to limit the technical scope of the invention to only those particular disclosed dimensions, materials, shapes, and the like unless otherwise specified.

### First Embodiment

Embodiments in which information the processing apparatus, the system, and the programs according to the present disclosure are applied to a vehicle dispatching system of a taxi will now be described.

According to the disclosed embodiments, the pick-up vehicle that picks up the user is a taxi. However, the disclosed pick-up vehicle is not limited to taxis.

The disclosed pick-up vehicle may be any vehicle capable of picking-up a user based on the user's desires.

For example, vehicle used for the so-called ride share, in which one or more users interact with vehicle driven by the driver, may be the pick-up vehicle.

### (Outline of System)

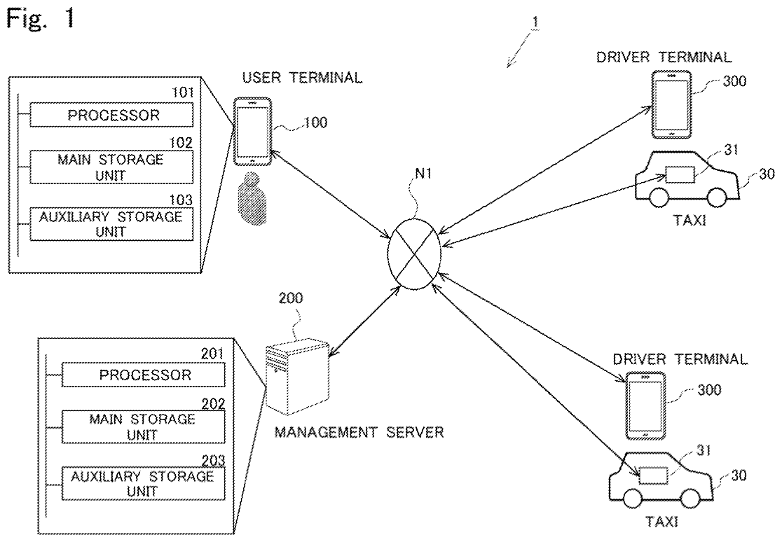

FIG. 1 is a diagram showing a schematic configuration of a vehicle allocation system according to the present embodiment.

The vehicle dispatching system 1 includes a user terminal 100 owned by a user, a management server 200, a driver terminal 300 owned by a driver of each of several taxis 30, and an in-vehicle device 31 mounted on each of the several taxis 30.

In the vehicle dispatching system 1, user terminal 100, management server 200, each driver terminal 300, and each in-vehicle device 31 are connected to each other via a network N1. The network N1 may be, for example, a WAN (Wide Area Network) which is a worldwide public communication network such as the Internet, or a telephone communication network such as a cellular telephone.

The user terminal 100 is a terminal owned by a user who wishes to be picked up by a taxi. The user terminal 100 may transmit vehicle request information based on user operations. The vehicle request information includes information indicating the user's desire to be picked-up by a vehicle.

The vehicle request information contains a desired boarding location and a desired boarding time about the user.

User terminal 100 includes a computer having a processor 101, a main storage unit 102, and an auxiliary storage unit 103.

Processor 101 is, for example, a CPU (Central Processing Unit) or a DSP (Digital Signal Processor).

The main storage unit 102 is, for example, a RAM (Random Access Memory).

The auxiliary storage unit 103 is, for example, a ROM (Read Only Memory) or a flash memory. Further, the auxiliary storage unit 103 may include a removable medium (e.g., a portable recording medium).

Here, the removable media is, for example, a USB memory or an SD card.

The auxiliary storage unit 103 stores an operating system (OS), various programs, various information tables, and the like.

The processor 101 loads the program stored in the auxiliary storage unit 103 into the main storage unit 102 and executes the program, thereby realizing control of the storage unit 100 as described later.

User terminal 100 may be a smart phone, a tablet computer, a mobile computer, or a wearable computer.

Management server 200 is a server device for managing several taxis 30.

Management server 200 receives a user's request for pick-up by a vehicle.

Management server 200 receives vehicle request information transmitted from the user terminal 100.

Management server 200 also receives current position and scheduled travel of each taxi 30 from in-vehicle device 31 of each taxi 30.

Management server 200 stores current position and scheduled travel of the taxis 30 as vehicle information.

Management server 200 selects a pick-up vehicle for picking up the user from the several taxis 30.

In addition, management server 200 instructs the driver of the selected pick-up vehicle to pick up the user.

At this time, management server 200 transmits the user's vehicle request information to the driver terminal 300.

Driver terminal 300 may be a terminal of the same type as user terminal 100 described above.

Management server 200 is configured to include a conventional computer.

The computer of the management server 200 includes a processor 201, a main storage unit 202, and an auxiliary storage unit 203.

Specific examples of the processor 201, the main storage unit 202, and the auxiliary storage unit 203 may be the same as the specific examples of the processor 101, the main storage unit 102, and the auxiliary storage unit 103 in the computer constituting the user terminal 100, respectively.

In addition, the auxiliary storage unit 203 may be an HDD (Hard Disk Drive) or a disc recording medium such as a CD-ROM, a DVD disc, or a Blu-ray disc.

In the management server 200, the auxiliary storage unit 203 stores an operating system (OS), various programs, various information tables, and the like.

The processor 201 loads the program stored in the auxiliary storage unit 203 into the main storage unit 202 and executes the program, thereby realizing control of the management server 200 as described later.

However, some or all of the functions of management server 200 may be implemented by hardware circuits such as an ASIC and a FPGA.

Additionally, the management server 200 does not necessarily have to be achieved by a single physical configuration, and may be formed by several computers operating in coordination.

In addition, in this embodiment, the user deposits his/her baggage (i.e., user baggage) in a public locker.

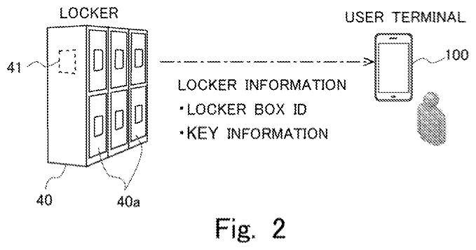

FIG. 2 is a diagram showing an outline of a key system of a locker in which a user has deposited a user baggage.

As shown in FIG. 2, locker 40 includes several locker boxes 40a each having a baggage and a store space.

Locker boxes 40a of locker 40 are configured to be lockable and unlockable.

Locker 40 is provided with a locker management device 41.

Locker management device 41 manages locker information including the key information of locker boxes 40a.

Key information is information for unlocking the locked locker boxes 40a.

Locker management device 41 includes a storage device in which locker information is stored. The locker information includes locker box IDs of locker boxes 40a and the key information of the locker boxes 40a are linked to each other.

The locker box ID is an identification information for identifying locker boxes 40a in locker 40.

The locker box ID 40 also includes information (e.g., the position information of locker 40) for specifying a particular locker box.

The locker management device 41 is configured to be able to transmit and receive locker information to and from an external terminal by short-range radio communication.

The external terminal receives locker information transmitted from locker management device 41.

As a result, locker boxes 40a corresponding to locker information can be unlocked using the external terminal.

That is, when the key information included in locker information is transmitted from the external terminal to locker management device 41, locker boxes 40a corresponding to the key information are unlocked.

Therefore, when the user deposits his/her user baggage in any of the locker boxes 40a in locker 40, locker information corresponding to locker box 40a, which is the deposit location of user baggage, is received by user terminal 100.

At this time, locker information corresponding to locker box 40a, which is deposit location of user's baggage, is transmitted from locker management device 41.

This allows the user to unlock the locked locker box 40a with the user baggage stored therein using user terminal 100 when he/she removes the user's baggage from locker box 40a by himself/herself.

Also, if the user wishes to collect the user's baggage deposited in locker boxes 40a of locker 40, by a pick-up vehicle, the user terminal 100 is operable to transmit the user's vehicle request information and locker information to the management server 200.

The management server 200 transmits vehicle request information and locker information to the driver terminal owned by the driver of the pick-up vehicle 300.

This allows locker box 40a, which contains the user's baggage and is locked, to be unlocked using the driver terminal 300 when the pick-up vehicle's driver retrieves the user's baggage from locker box 40a.

### (Function Configuration)

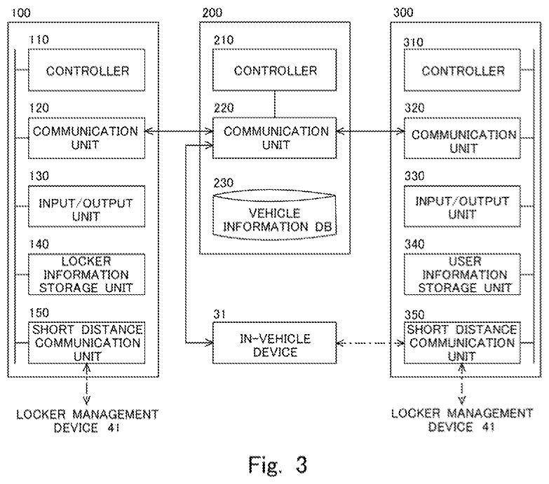

Next, a functional configuration of each of user terminal 100, management server 200, and driver terminal 300 constituting the vehicle allocation system 1 according to the present embodiment will be described with reference to FIG. 3.

FIG. 3 is a block diagram schematically showing an exemplary functional configuration of each of a user terminal 100, a management server 200, and a driver terminal 300.

### (User Terminal)

User terminal 100 has a controller 110, communication unit 120, input/output unit 130, locker information storage unit 140, and short distance communication unit 150.

The controller 110 includes a function of performing arithmetic processing for controlling the user terminal 100.

Controller 110 may be implemented by the processor 101.

Communication unit 120 is operable for connecting user terminal 100 to the network N1.

Communication unit 120 includes a communication interface.

Communication unit 120 utilizes mobile communication services such as 3G (3rd Generation or Long Term Evolution, for example.

Communication unit 120 may communicate over network N1 with other devices, including management server 200.

As will be described later, controller 110 performs a process for transmitting user information including the user's vehicle request information and locker information to the management server 200 via communication unit 120.

The input/output unit 130 has a function of accepting input operations performed by a user and a function of presenting information to a user.

Specifically, input/output unit 130 includes a touch panel display.

In user terminal 100, when controller 110 operates a predetermined application, the user can perform an input operation on the touch panel display of the input/output unit 130.

For example, the user operates the touch panel display of then input/output unit 130 when user baggage is deposited in locker box 40a of locker 40.

As a result, the user requests locker management device 41 to transmit locker information. The user receives locker information transmitted from the locker management device 41 by the user terminal 100.

Locker information storage unit 140 has a function of storing locker information received from the locker management device 41.

The locker information storage unit 140 can be realized by the secondary storage unit 103. The short distance communication unit 150 has a function of communicating with locker management device 41.

The short distance communication unit 150 includes a communication interface using a predetermined short-range radio communication standard.

Examples of the predetermined short-range radio communication standard include Bluetooth (registered trademark) LowEnergy standard, WiFi (registered trademark), NFC (Near Field Communication), and the like.

The controller 110 performs a process of receiving locker information from locker management device 41 via short distance communication unit 150, and a process of storing the received locker information in locker information storage unit 140.

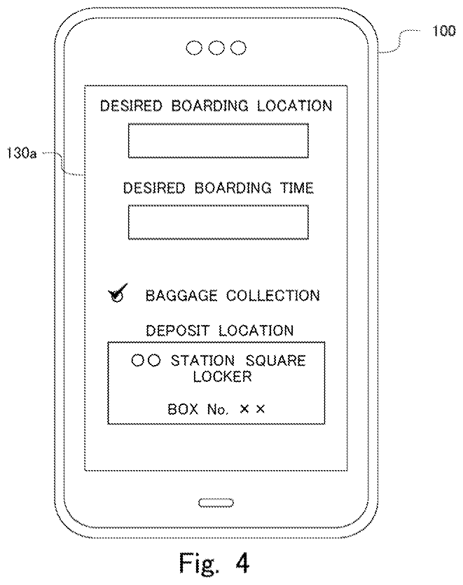

The operations performed by the user on user terminal 100 when the user requests the pick-up by vehicle will now be described with reference to FIG. 4.

FIG. 4 is a diagram illustrating exemplary operating screens displayed on the touch panel display 130a of the input/output unit 130 when user terminal 100 activates the predetermined application.

In the operating display shown in FIG. 4, the user inputs the desired boarding location and the desired boarding time.

It is also possible to enter the user's current position as the desired boarding location.

It is also possible to enter “as early as possible” as the desired boarding time.

When the user desires to collect the user's baggage stored in locker box 40a of locker 40 by the pick-up vehicle, the user checks the “baggage collection” checkbox in the operating window shown in FIG. 4.

As shown in FIG. 4, the deposit location of the user's baggage is displayed on the operating window.

This deposit location displaying process is performed by the controller 110 reading locker box ID included in the locker information stored in locker information storage unit 140.

The locker box ID included in the locker information is that locker box ID corresponding to locker box 40a of locker 40 that contains the user's baggage.

As discussed below, the controller 110 generates and transmits user information in management server 200 based on such user interaction.

### (Management Server)

The management server 200 includes a controller 210, a communication unit 220, and vehicle information databases (vehicle information DBs) 230.

The controller 210 includes a function of performing arithmetic processing for controlling the management server 200.

Controller 210 may be implemented by the processor 201.

Communication unit 220 is a communication device for connecting management server 200 to the network N1.

Communication unit 220 includes, for example, a LAN (Local Area Network) interface board, or wireless communication circuits for wireless communication.

Controller 210 performs a process for receiving user information transmitted from user terminal 100 via communication unit 220.

Further, controller 210 performs a process for transmitting the driver terminal 300 for the pick-up vehicle driver via communication unit 220 with respect to user information received from the user terminal 100 and driving information described later.

Further, the controller 210 performs a process for receiving the current position and the scheduled travel of each taxi 30 transmitted from the in-vehicle device 31 of each taxi 30 via communication unit 220.

Here, the scheduled travel of the taxi 30 includes the current destination of the taxi 30 and the scheduled arrival times of the taxi 30 at the destination location.

Incidentally, in-vehicle device 31 is provided with a GPS device and a navigation system.

The GPS device detects the current position of the taxi 30 equipped with the in-vehicle device 31.

In the navigation system, the destination of the taxi 30 on which the in-vehicle device 31 is mounted and the scheduled arrival time at the destination are set.

Then, the current position of the taxi 30 detected by the GPS device is transmitted from the in-vehicle device 31.

The scheduled travel including the destination of the taxis 30 set in the navigation system and the scheduled arrival time at the destination is transmitted from the in-vehicle device 31.

Further, the controller 210 performs a process for storing the current position and the scheduled travel of each taxi 30 received from in-vehicle device 31 of each taxi 30 as a vehicle information in vehicle information database 230.

Vehicle information DB 230 is constructed in the auxiliary storage unit 203 of management server 200 by executing a program of the database management system (Database Management System) by the processor 201.

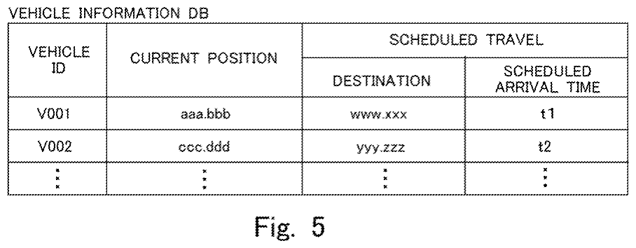

FIG. 5 is a diagram showing an exemplary table configuration of the vehicle information database 230 in management server 200.

As shown in FIG. 5, vehicle information database 230 includes a vehicle ID field, a current position field, and a scheduled travel field.

In vehicle ID field, a vehicle ID, which is an identification information for specifying taxis, is entered.

In current position field, the present position of the taxi 30 (corresponding to a vehicle ID entered in the vehicle ID field) is entered.

In the scheduled travel field, the destination of the taxi 30 (corresponding to a vehicle ID entered in vehicle ID field) and the scheduled arrival time to the destination are entered. Each time a current position is received via the communication unit 220, updated information is entered in the current position fields of the taxis 30 in motion

Note that in connection with the vehicle information for the respective taxis 30, not necessarily both current position and scheduled travel of information need be received from in-vehicle device 31.

For example, a configuration may be employed in which management server 200 receives only current position from in-vehicle device 31 as a vehicle information for the respective taxis 30. Only vehicle IDs and current position of the taxis 30 are stored in vehicle information database 230 of management server 200.

### (Driver Terminal)

Referring to FIG. 3, the driver terminal 300 includes a controller 310, a communication unit 320, an input/output unit 330, a user information storage unit 340, and a short distance communication unit 350.

The controller includes a function of performing arithmetic processing for controlling the user terminal 100.

Controller 310 may be implemented by a processor of a computer included in driver terminal 300.

The communication unit 320 is capable of connecting the driver terminal 300 to the network N1.

The specific configuration of the communication unit 320 may the same as that of communication unit 120 of user terminal 100.

The controller 310 receives user information and driving information transmitted from management server 200 via the communication unit 320.

The input/output unit 330 has a function of accepting input operations performed by the driver, and a function of presenting information to the driver.

Specifically, input/output unit 330 includes a touch panel display, similar to the input/output unit 130 of user terminal 100.

In the driver terminal 300, controller 310 operates a predetermined application (driver application) so that the driver can perform input operations on the touch panel display of input/output unit 330.

User information storage unit 340 is capable of storing user information received from management server 200.

User information storage unit 340 can be realized by a secondary storage unit of a computer included in driver terminal 300.

Like short distance communication unit 150 of user terminal 100, short distance communication unit 350 has a function of communicating with the locker management device 41.

The specific configuration of short distance communication unit 350 may be the same as that of short distance communication unit 150 of user terminal 100.

However, short distance communication unit 350 also has a function of communicating with in-vehicle device 31 of the taxi 30.

The pick-up vehicle driver uses driver terminal 300 to collect the user's baggage from locker box 40a of locker 40 that contains the user's baggage.

Specifically, the pick-up vehicle driver operates the touch panel display of input/output unit 330 in order to initial the operation of removing the user's baggage from the locker box 40a. This causes the key information to be transmitted to the locker management device 41.

At this time, the key information is read from user information storage unit 340 and then sent to the locker management device 41.

When the locker management device 41 receives the key information transmitted from driver terminal 300, that locker box 40a containing the user's baggage is unlocked.

As a result, the driver of the pick-up vehicle can remove the user baggage from the locker box 40a.

That is, when the locker information including the key information is received by the driver terminal 300, the user baggage is permitted to be received from locker box 40a by the driver of the pick-up vehicle.

### (Information Processing in Systems)

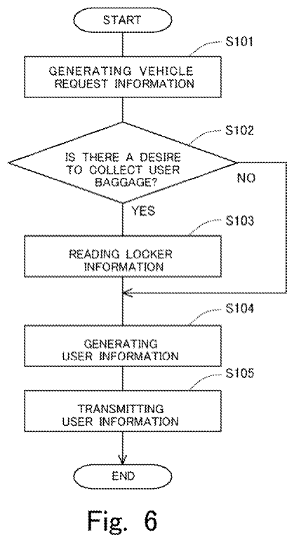

Next, the information processing executed in user terminal 100 when the user requests the arrival location and time by the taxi will be described based on FIG. 6.

FIG. 6 is a flow chart showing the flow of information processing executed by controller 110 of user terminal 100.

In this flow, first, in S101, a vehicle request information containing desired boarding location and desired boarding time about the user is generated.

Here, vehicle request information is generated based on information inputted by the user on the operating window of user terminal 100 shown in FIG. 4.

Next, in S102, it is determined whether or not there is a desire to collect user baggage by the pick-up vehicle.

If the check box of “baggage collection” is checked by the user in the operating window shown in FIG. 4, an affirmative determination is made in S102.

If an affirmative determination is made in S102, then in S103, locker information stored in locker information storage unit 140 is read.

The read locker information includes locker box ID and the key information corresponding to that locker box 40a in which user baggage that the user wants to collect is accommodated.

Next, in S104, user information is generated based on vehicle request information generated in S101 and locker information read in S103.

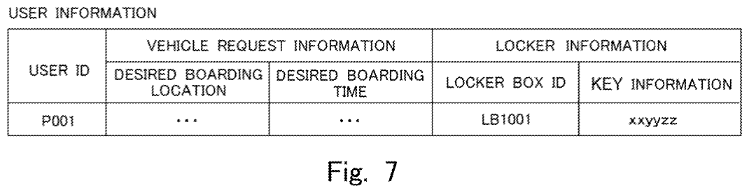

FIG. 7 is a diagram showing an exemplary table structure of user information generated in S104.

As shown in FIG. 7, the user information includes a user ID (which is an identification information for identifying a user), is linked to vehicle request information and locker information.

Next, in S105, user information generated by S104 is transmitted to management server 200 via communication unit 120.

When a negative determination is made in S102, that is, when the user does not wish to collect user baggage by pick-up vehicle, S104 and S105 processes are executed without executing S103 processes.

In this situation, user information that does not include locker information is generated and is sent to management server 200.

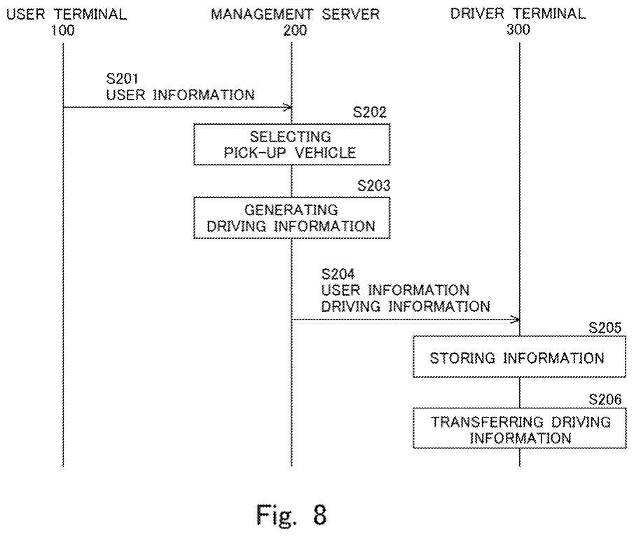

Next, information processing in the vehicle dispatching system 1 when a user information including vehicle request information and locker information is transmitted from the user terminal 100 will be described with reference to FIG. 8.

FIG. 8 is a sequence diagram showing a flow of information in the vehicle dispatching system 1 and information processing executed in each of the management server 200 and the driver terminal 300.

In the vehicle dispatching system 1, a user information including vehicle request information and locker information as shown in FIG. 7 is terminated from user terminal 100 to management server 200 (S201).

At management server 200, when a user information is received, a pick-up vehicle is selected from the several taxis 30 (S202).

The pick-up vehicle selected here is a vehicle which collects the user's baggage from locker box 40a in which the user baggage is deposited, and then picks-up the user.

The taxi 30 suitable for picking-up the user at the user's desired boarding location and the user's desired boarding time, after passing by locker 40 in which the user's baggage is deposited, is selected as the pick-up vehicle.

Here, the selection of the pick-up vehicle in S202 is performed based on vehicle information for the taxis stored in vehicle information database 230 and the locker box IDs included in vehicle request information and locker information.

At this time, the position of locker 40 where user baggage is deposited can be obtained on the basis of locker box ID.

Thus, for example, if the desired boarding time in the vehicle request information is “as early as possible”, the taxi 30 of the several taxis 30 whose current position in vehicle information is closest to the position of locker 40 where the user's baggage is deposited may be selected as pick-up vehicle.

Also, a particular taxi 30 may be selected as the pick-up vehicle which can be determined to be able to arrive at the desired boarding location by the desired boarding time after passing by locker 40 on which user baggage is deposited, after arriving at the current destination, based on scheduled travel in vehicle information.

In addition, management server 200 generates driving information that contains the driving route of the pick-up vehicle selected in S202 (S203).

The driving route is the route for the pick-up vehicle to drive to the user's desired boarding location via locker 40 on which the user's baggage is deposited.

S202 and S203 processes are executed by controller 210 in the management server 200.

In addition, controller 210 may set a time (hereinafter, sometimes referred to as “collection time”) at which the driver of the pick-up vehicle should collect the user's baggage from locker box 40a of locker 40 while the pick-up vehicle is heading to the user's desired boarding location.

The controller 210 may include the collection period in the driving information.

It is expected that the pick-up vehicle can arrive at the desired boarding location by the desired boarding time if the pick-up vehicle driver collects user baggage from locker box 40a of locker 40 at the collection time.

User information received from the user terminal 100 and driving information generated by S203 are transmitted from the management server 200 to the driver terminal 300 (S204).

In the driver terminal 300, when user information and driving information are received, the user information is stored in user information storage unit 340 (S205).

This allows the pick-up vehicle driver to use the driver terminal 300 to unlock locker box 40a of locker 40 in which user baggage is housed.

Furthermore, in the driver terminal 300, the received driving information is transferred via the short distance communication unit 350 to in-vehicle device 31 of pick-up vehicle (S206). In in-vehicle device 31, when a driving information is received, the driving route contained in driving information is displayed on monitors.

The driving route towards the user's desired boarding location via locker 40 in which the user baggage is deposited is displayed on the monitors.

This allows the pick-up vehicle driver to drive the vehicle along the driving route.

In the vehicle dispatch system 1 described above, the driver of the pick-up vehicle receives user information from the management server 200 to the driver terminal 300, so that the driver terminal 300 can obtain the vehicle request information and the locker information. The driver terminal 300 is able to obtain the vehicle request information, allowing the pick-up vehicle to pick-up the user at the user's desired boarding time and the user's desired boarding location.

The vehicle terminal 300 obtains the locker box ID contained in the locker information, thereby allowing the pick-up vehicle to go by locker 40 of the user's baggage's deposit location on its way to the location where the user is picked-up.

Then, vehicle terminal 300 obtains the key information included in the locker information, so that the driver of pick-up vehicle can remove the user's baggage from locker box 40a in which user baggage is stored.

According to the vehicle dispatch system 1 described above, the user baggage left in the locker box 40a of locker 40 by the user can be collected by the pick-up vehicle prior to picking-up the user.

In the present embodiment, the user terminal 100 corresponds to “user terminal”.

Management server 200 corresponds to the “information processing apparatus” disclosed herein.

In addition, the pick-up vehicle driver correspond to “vehicle terminal” according to the present disclosure the own driver terminal 300.

Further, in the present embodiment, locker box 40a of locker 40 in which user baggage is deposited corresponds to “deposit location of user baggage” and “storage device” according to the present disclosures.

Vehicle request information corresponds to the “first information” of the present disclosure. Locker box ID included in locker information corresponds to the “second information” of the present disclosure.

The key information included in locker information corresponds to the “third information” of the present disclosure.

In this embodiment, user information and driving information are transmitted from management server 200 to the driver terminal 300 owned by the pick-up vehicle driver. However, the destination of this information may be the vehicle device 31 of the pick-up vehicle 30.

The locker information included in the user information may be transferred from in-vehicle device 31 to driver terminal 300.

This allows the pick-up vehicle driver to unlock the locker box 40a of locker 40 containing the user's baggage using the driver terminal 300.

Further, in the present embodiment, user information transmitted from the user terminal 100 to the management server 200 does not necessarily include the key information corresponding to the locker box 40a of locker 40 in which user baggage is stored.

In other words, user information transmitted from user terminal 100 to management server 200 may include permission information, which is information for permitting the issuance of the key information, instead of the key information itself.

In this situation, the user information sent from management server 200 to driver terminal 300 will also contain the authorization information.

Then, when the driver of the pick-up vehicle tries to retrieve the user's baggage from locker box 40a of locker box 40, the driver of the pick-up vehicle will transmit permission information from the driver terminal 300 to the locker management device 41.

Upon receipt of the authorization information, the locker management device 41 will transmit the key information corresponding to locker box 40a of locker 40 in which the user's baggage was deposited to the driver terminal 300.

Even in such cases, the pick-up vehicle driver can unlock locker box 40a of locker 40 containing the user's baggage using driver terminal 300.

The key information for unlocking locker boxes 40a described above are not necessarily transmitted from locker management device 41 provided in locker 40 to user terminal 100 or driver terminal 300.

For example, a configuration may be employed in which the key information is sent from a server that manages the key information located in a location different from locker 40 to the user terminal 100 or driver terminal 300 over the network N1.

### Second Embodiment

Next, a vehicle dispatching system according to the second embodiment will be described. Hereinafter, only points different from the vehicle allocation system according to the first embodiment will be described.

In the present embodiment, the user's baggage is a product purchased by a user at a store. The user then deposits the user baggage in the store.

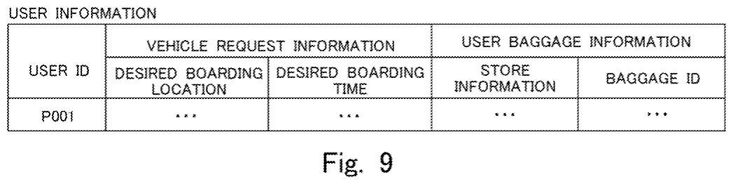

In this embodiment, user terminal 100 generates user information including: vehicle request information; and user baggage information, which will be described later. FIG. 9 is a diagram showing an exemplary table configuration of user information generated by the user terminal 100 in the present embodiment.

As shown in FIG. 9, user IDs of the user information are linked to vehicle request information and user baggage information.

The user ID is the identification information used to identify the user.

As shown in FIG. 9, user baggage information includes store information and baggage ID. The store information is information for specifying a store in which a user has deposited a user baggage.

Store information also includes store location information.

Baggage information is identifying information for identifying baggage that the user has deposited in the store.

Such user baggage information may be received by the user terminal 100, for example, from a store terminal provided in a store that purchased user baggage (i.e., the store that deposited user baggage).

User baggage information may be read from the tags that come with the user baggage by user terminal 100 if the products sold in the store come with tags that remember this information.

In the present embodiment, a user information including vehicle request information and user baggage information as shown in FIG. 9 is transmitted from the user terminal 100 to the management server 200.

In the management server 200, the pick-up vehicle is selected based on vehicle information of the taxis stored in vehicle information database 230 and the shop information included in the vehicle request information and user baggage information.

Taxi 30 which is suitable for picking-up the user at the user's desired boarding time and the user's desired boarding location after passing by the store where the user's baggage is deposited, is selected as the pick-up vehicle.

The method of selecting the pick-up vehicle at this time is the same as the method of selecting the pick-up vehicle performed on the basis of vehicle information and locker box IDs included in vehicle request information and locker information for the taxis in the first embodiment.

In the management server 200, driving information containing the driving route is generated. The driving route is a route for the pick-up vehicle to travel to the user's desired boarding location via the store where user baggage is deposited.

The driving information may include a collection time.

The collection time is the time that the driver of the vehicle must collect the user baggage from the store while the pick-up vehicle is heading to desired boarding location.

The user information received from the user terminal 100 and the generated driving information are transmitted from the management server 200 to the driver terminal 300 of the driver of the pick-up vehicle.

This allows the driver of pick-up vehicle to present the baggage ID of the user's baggage using the driver terminal 300 at the store where user baggage is deposited.

Consequently, the pick-up vehicle driver can receive user baggage from the store.

In other words, in the present embodiment, the baggage ID functions as information indicating that the driver of the pick-up vehicle is permitted to receive the user's baggage from the store in which the user's baggage is located.

In the present embodiment, the vehicle terminal 300 obtains the store information included in user baggage information, so that pick-up vehicle can pass by the store where user baggage is deposited on the way to the location where the user is to be picked up.

The vehicle terminal 300 then obtains the baggage ID contained in the user baggage information, allowing the pick-up vehicle driver to receive the user's baggage from the store where the user's baggage is deposited.

Therefore, according to the vehicle allocation system of the present embodiment, the user's baggage that the user has deposited in the store can be collected by the pick-up vehicle prior to picking up the user.

In the present embodiment, the store where the user's baggage is deposited corresponds to “deposit location of user baggage” according to the present disclosure.

In the present embodiment, the store information included in user baggage information corresponds to the second information.

Baggage ID included in the user baggage information corresponds to the “third information” of the present disclosure.

The deposit location of the user's baggage in the present embodiment is not limited to a store. For example, the vehicle dispatching system according to the present embodiment can be applied to a vehicle dispatching system in which the user's baggage is deposited in hotels or the like and then collected by a pick-up vehicle.

### Other Embodiments

The above-described embodiments are examples, and the present disclosure can be implemented with changes made as appropriate without departing from the gist of the present disclosure. The processing and units described in the present disclosure can be implemented by being freely combined unless technical conflicts arise.

Moreover, the processing described as processing to be performed by a single apparatus may be performed by more than one apparatuses in a shared manner. Alternatively, the processing described as processing to be performed by different apparatuses may be performed by a single apparatus. In a computer system, it can be flexibly changed which hardware component (server component) is used to implement each function.

The present disclosure can also be implemented by providing a computer program designed to implement the functions described in the above embodiments to a computer, and by one or more processors included in the computer reading and executing the program. Such a computer program may be provided to the computer by using a non-transient computer-readable storage medium that can be connected to a system bus of the computer, or may be provided to the computer via a network. Examples of the non-transient computer-readable storage medium include any types of disks/discs such as magnetic disks (Floppy® disk, hard disk drive (HDD), and the like) and optical discs (CD-ROM, DVD disc, Blu-ray Disc, and the like), read-only memory (ROM), random access memory (RAM), EPROM, EEPROM, magnetic card, flash memory, optical card, and any type of media suitable for storing therein electronic instructions.

What is claimed is:

1. An information processing apparatus comprising a controller,
the controller configured to execute:
obtaining user information including first information indicating a desired boarding location and a desired boarding time for a user who wishes to be picked-up by a vehicle, second information indicating a deposit location at which the user has deposited a user baggage, and third information indicating that a driver of a pick-up vehicle picking up the user is permitted to receive the user baggage from the deposit location; and
transmitting the user information to a vehicle terminal associated with the pick-up vehicle.

2. The information processing apparatus according to claim 1, wherein
the controller further executes:
obtaining vehicle information for each of a plurality of vehicles, the vehicle information including at least one of current vehicle position and scheduled vehicle travel, and
selecting the pick-up vehicle from the plurality of vehicles based on the vehicle information, the first information, and the second information.

3. The information processing apparatus according to claim 1, wherein
the controller further executes:
based on the first information and the second information, generating driving information for the pick-up vehicle including a driving route to travel to the desired boarding location of the user via the deposit location, and
transmitting the driving information to the vehicle terminal.

4. The information processing apparatus according to claim 3, wherein
the driving information contains information about when the driver of the pick-up vehicle should receive the user baggage from the deposit location.

5. The information processing apparatus according to claim 1, wherein
the deposit location is a storage device having a space for storing a baggage and being operable to be locked and unlocked, and
the third information includes key information operable for unlocking the storage device locked with user baggage stored therein.

6. The information processing apparatus according to claim 1, wherein
the third information includes baggage ID, which is information for specifying the user baggage.

7. The information processing apparatus according to claim 1, wherein
the user information is received from a user terminal.

8. The information processing apparatus according to claim 1, wherein
the vehicle terminal is a driver terminal for the driver of the pick-up vehicle.

9. The information processing apparatus according to claim 1, wherein
the vehicle terminal is an in-vehicle device provided on the pick-up vehicle.

10. A system including:
a user terminal fora user who wishes to be picked up by a vehicle,
an information processing apparatus for receiving user information from the user terminal, the user information including first information indicating a desired boarding location and a desired boarding time for the user, second information indicating a deposit location at which the user deposited a user baggage, and third information indicating that a driver of a pick-up vehicle picking-up the user is permitted to receive the user baggage from the deposit location, and
a vehicle terminal associated with the pick-up vehicle, wherein the vehicle terminal receiving the user information from the information processing apparatus.

11. The system according to claim 10, wherein
the information processing apparatus
obtains the vehicle information for each of a plurality of vehicles, the vehicle information including at least one of current vehicle position and scheduled vehicle travel, and
selects the pick-up vehicle from the plurality of vehicles based on the vehicle information for each of the plurality of vehicles, the first information, and the second information.

12. The system according to claim 10, wherein
the information processing apparatus,
based on the first information and the second information, generates driving information including a driving route for the pick-up vehicle to travel to the desired boarding location of the user via the deposit location, and
transmits the driving information to the vehicle terminal.

13. The system according to claim 12, wherein
the driving information contains information about when the driver of the pick-up vehicle should receive user baggage from the deposit location.

14. The system according to claim 10, wherein
the deposit location is a storage device having a space for storing baggage and operable for being locked and unlocked, and
the third information includes key information operable for unlocking the storage device locked with user baggage stored therein.

15. The system according to claim 10, wherein
the deposit location is a storage device having a space for storing baggage and operable for being locked and unlocked,
the key information, which is operable to unlock the storage device locked with the user baggage stored, is managed by a management device,
the vehicle terminal transmits the third information included in the user information received from the information processing apparatus to the management device,
the vehicle terminal receives the key information from the management device.

16. The system according to claim 10, wherein
the third information includes baggage ID, which is information for specifying the user baggage.

17. A non-transient storage medium storing a program for causing a processor controlling a user terminal for a user who wishes to be picked-up by a vehicle to execute an information processing method, wherein
the information processing method comprises:
generating user information including first information indicating a desired boarding location and a desired boarding time for the user, second information indicating a deposit location at which the user deposited a user baggage, and third information indicating that a driver of a pick-up vehicle picking up the user is permitted to receive the user baggage from the deposit location, and
transmitting the user information to an information processing apparatus capable of communicating with a vehicle terminal associated with the pick-up vehicle.

18. The non-transient storage medium according to claim 17, wherein the deposit location is a storage device having a space for storing a baggage and operable for being locked and unlocked, and
the third information includes key information operable for unlocking the storage device locked with user baggage stored therein.

19. The non-transient storage medium according to claim 18, wherein
the information processing method further includes
receiving the key information transmitted from a management device that manages the key information.

20. The non-transient storage medium according to claim 17, wherein
the third information includes baggage ID, which is information for specifying the user baggage.
